(19) United States
(12) Patent Application Publication
(10) Pub. No.: US 2011/0013703 A1
(43) Pub. Date: Jan. 20, 2011

(54) MOBILE DISPLAY INTERFACE

(75) Inventors: Scott Guo, San Jose, CA (US); Manikantan Jayaraman, San Jose, CA (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/158,980

(22) PCT Filed: Dec. 21, 2006
(86) PCT No.: PCT/IB2006/054987

§ 371 Date: Oct. 8, 2010

Related U.S. Application Data
(60) Provisional application No. 60/752,835, filed on Dec. 21, 2005.

(51) Int. Cl. H04N 11/02

(52) U.S. Cl. 375/240.28; 375/E07.026

(57) ABSTRACT

An apparatus for encoding video display data comprises a transmitter that is configured to accept an RGB data signal from a source and a receiver that is configured to accept the RGB data signal from the transmitter. The RGB data signal comprises redundant synchronization information. Methods of using the apparatus are also provided.

This disclosure relates generally to the field of mobile computing devices and more specifically to the field of image formation on displays of such devices.

Mobile computing devices are increasingly being used to access, process, and present information in a wide variety of formats. Modern mobile computing devices such as laptop computers, cellular telephones, digital cameras and camcorders, portable music or multimedia players, and portable gaming devices often include displays that can be used to present various types of graphical information. As these mobile devices are used to present video information, additional video capabilities and displays are usually desired to support features such as three-dimensional graphics high-resolution television signals. Support for such features is typically associated with a need for increased bandwidth between a processor and a display of the device.

To form images on a display, image information, including video information, is usually formatted according to some predefined standard or specification that can be interpreted by the display. The Video Electronics Standards Association (VESA) publishes such standards. Among those VESA standards currently in use are the Monitor Control Command Set (MCCS) standard and the Mobile Display Digital Interface (MDDI) standard. Despite the existence of standards in this area, implementations that conform to those standards usually are targeted at a specific type of device.

Current systems and techniques generally require high pin counts or provide insufficient bandwidth for modern video and multimedia applications. Additionally, those systems typically lack sound protocols that allow for adequate error identification or are not readily scalable, if at all. Further, current systems can often require significant percentages of available power to drive displays using a large number of pin connections with resulting electromagnetic interference that can degrade performance.

The following presents a simplified summary in order to provide a basic understanding and high-level survey. This summary is not an extensive overview. It is neither intended to identify key or critical elements nor to delineate scope. The sole purpose of this summary is to present some concepts in a simplified form as a prelude to the more detailed description later presented. Additionally, section headings used herein are provided merely for convenience and both are not intended and should not be taken as limiting in any way.

An apparatus for encoding video display data comprises a transmitter that is configured to accept an RGB data signal from a source and a receiver that is configured to accept the RGB data signal from the transmitter wherein the RGB data signal comprises redundant synchronization information. The redundant synchronization information can comprise redundant horizontal synchronization information. The redundant synchronization information can also comprise redundant vertical synchronization information. The apparatus can further comprise an error detection unit that is configured to detect horizontal synchronization errors. Additionally or alternatively, the error detection unit can be configured to detect horizontal synchronization errors by counting pixels of a line.

The error detection unit of the apparatus can be configured to detect vertical synchronization errors. Additionally or alternatively, the error detection unit can be configured to detect vertical synchronization errors by counting lines of a frame. The apparatus can further comprise an application processor that is configured to provide the ROB data signal. Also, the apparatus can further comprise a display that is configured to use the RGB signal to form an image. The display can be a cathode ray tube, a plasma display, a liquid crystal display, a light emitting diode display, an organic light emitting diode display, an electrophoretic display, or another appropriate type of display.

A method for using display image information comprises formatting RGB image information into a frame comprising a plurality of lines, each line comprising a plurality of cells; defining the frame by setting a vertical synchronization value at an initial cell of an initial line of the frame and setting a horizontal synchronization value at a terminal cell of a terminal line of the frame; and setting redundant synchronization information in at least one cell of the plurality of cells of the plurality of lines in the frame. Setting redundant synchronization information can include setting redundant horizontal synchronization information in at least one of the plurality of cells of the plurality of lines of the frame. Setting redundant synchronization information can include setting redundant vertical synchronization information in at least one of the plurality of cells of the plurality of lines of the frame. The method can further comprise detecting synchronization errors by counting cells in at least one of the plurality of lines of the frame. Also, the method can further comprise detecting synchronization errors by counting lines of the frame.

A system for using display image information comprises means for formatting RGB image information into a frame comprising a plurality of lines, each line comprising a plurality of cells; means for defining the frame by setting a vertical synchronization value at an initial cell of an initial line of the frame and setting a horizontal synchronization value at a terminal cell of a terminal line of the frame; and means for setting redundant synchronization information in at least one cell of the plurality of cells of the plurality of lines in the frame. The means for setting redundant synchronization information can include means for setting redundant horizontal synchronization information in at least one of the plurality of cells of the plurality of lines of the frame. The means for setting redundant synchronization information can include means for setting redundant vertical synchronization information in at least one of the plurality of cells of the plurality of lines of the frame. The system can further comprise means for detecting synchronization errors by counting cells in at least one of the plurality of lines of the frame. Also, the system can further comprise means for detecting synchronization errors by counting lines of the frame.

The disclosed and described components and methods comprise one or more of the features described and particularly pointed out in the claims. The following description, including the drawings, set forth in detail certain specific illustrative components and methods. However, these components and methods illustrate only a few of the various ways in which the disclosed components and methods can be employed. Specific implementations of the disclosed and described components and methods can include some, many, or all of such components and methods, as well as their equivalents. Variations of the specific implementations and examples presented will be apparent from the following detailed description.

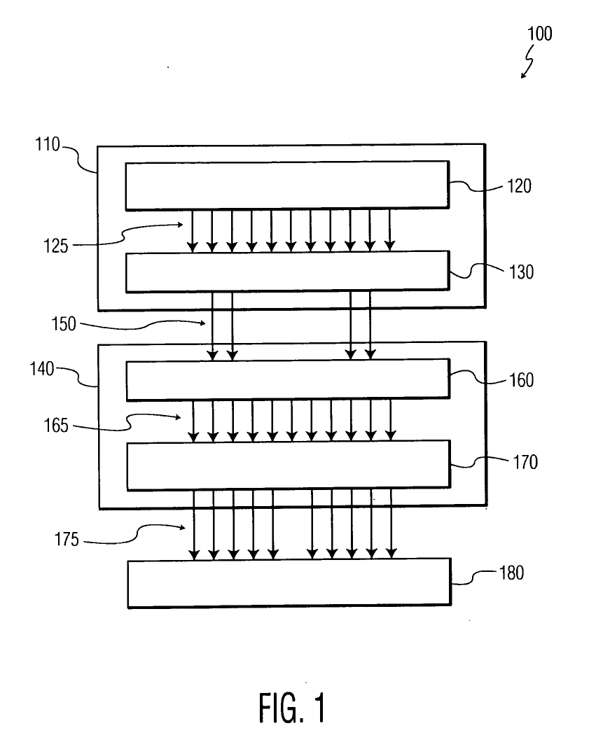

FIG. 1 is a system block diagram of a display interface system.

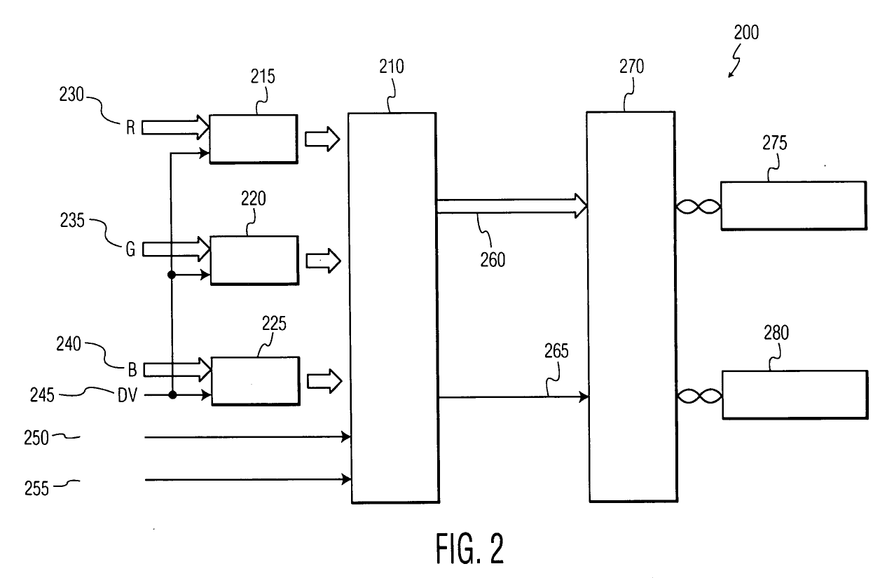

FIG. 2 is a system block diagram of transmission display interface.

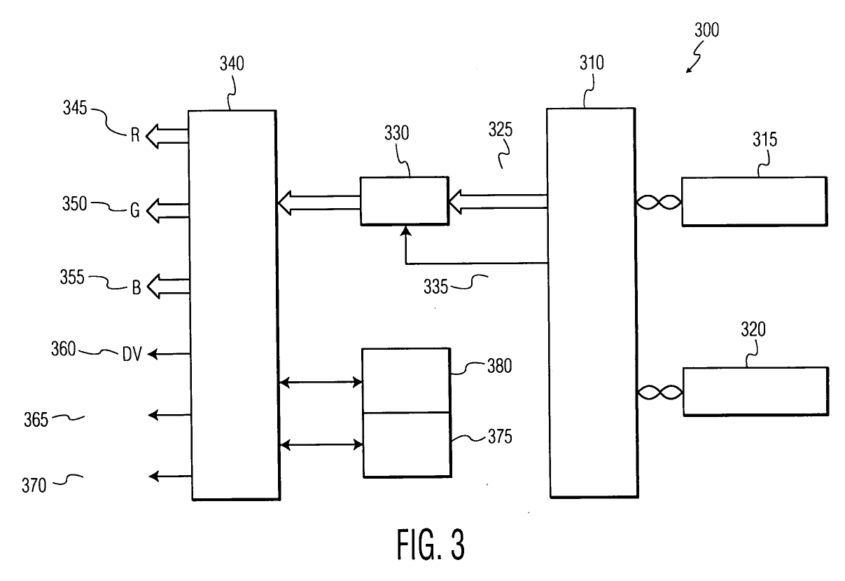

FIG. 3 is a system block diagram of a reception display interface.

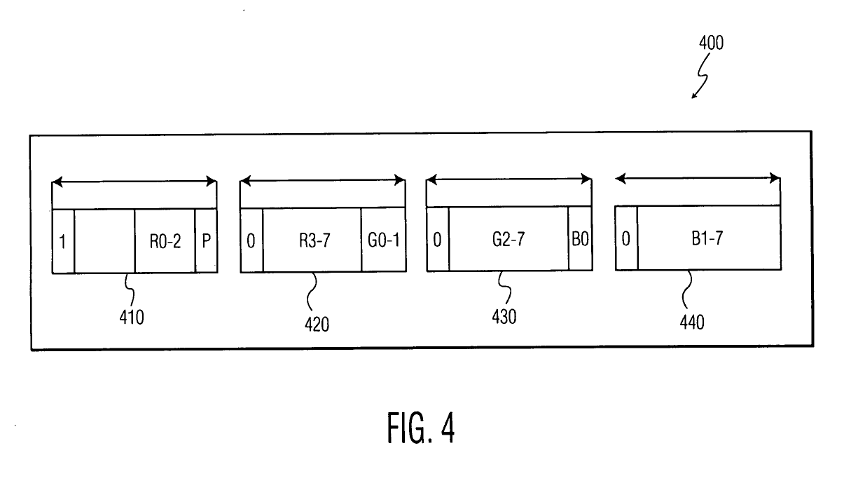

FIG. 4 is a record of a byte set.

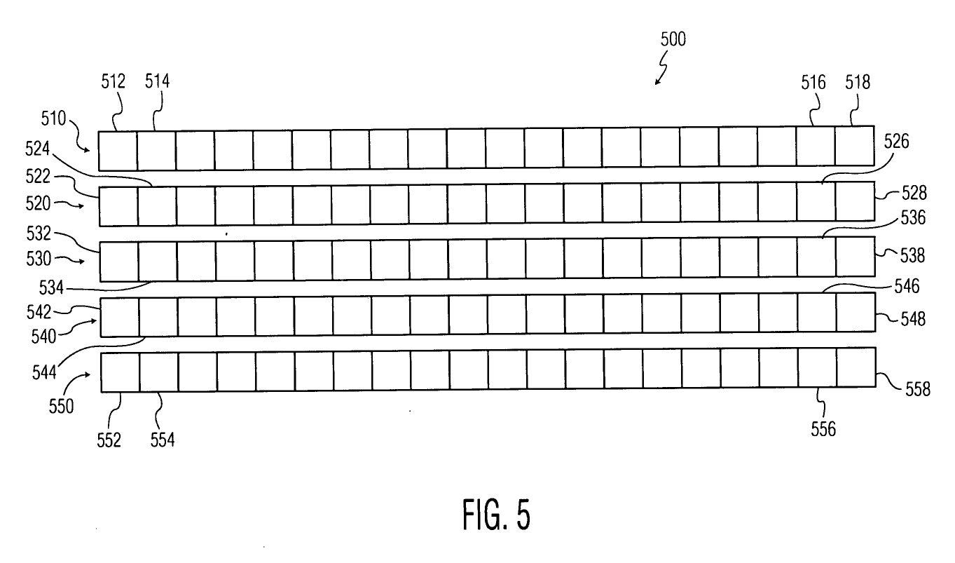

FIG. 5 is a record of a frame encoding.

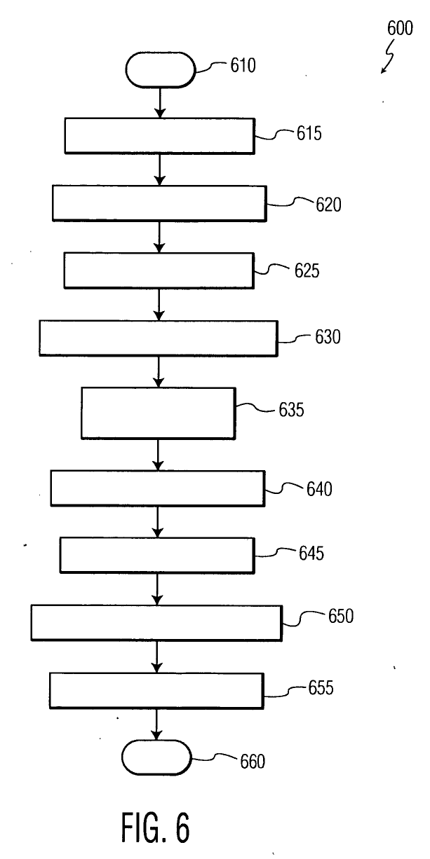

FIG. 6 is a flow diagram depicting a general processing flow of a method that can be employed in accordance with components that are disclosed and described herein.

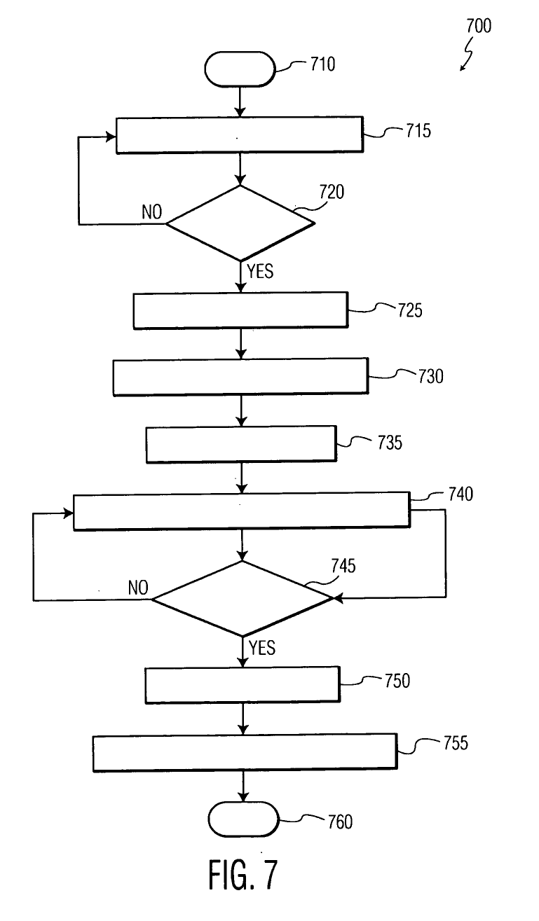

FIG. 7 is a flow diagram depicting a general processing flow of a method that can be employed in accordance with components that are disclosed and described herein.

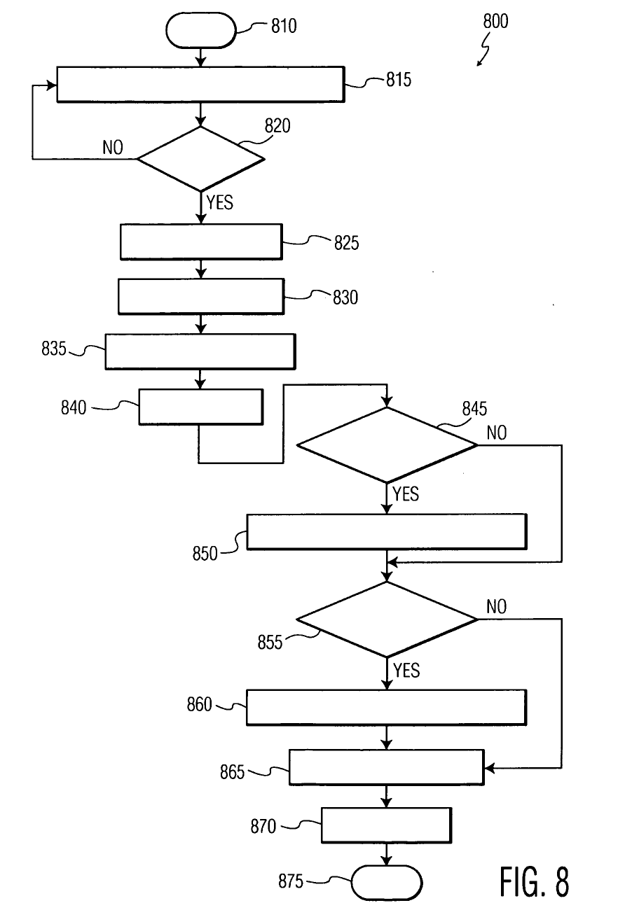

FIG. 8 is a is a flow diagram depicting a general processing flow of a method that can be employed in accordance with components that are disclosed and described herein.

As used in this application, the terms “component,” “system,” “module,” and the like are intended to refer to a computer-related entity, such as hardware, software (for instance, in execution), and/or firmware. For example, a component can be a process running on a processor, a processor, an object, an executable, a program, and/or a computer. Also, both an application running on a server and the server can be components. One or more components can reside within a process and a component can be localized on one computer and/or distributed between two or more computers.

Disclosed components and methods are described with reference to the drawings, wherein like reference numerals are used to refer to like elements throughout. In the following description, for purposes of explanation, certain specific details are set forth in order to promote a thorough understanding of the disclosed subject matter. In some examples, some of these specific details can be omitted or combined with others. In other instances, certain structures and devices are shown in block diagram form for ease of description. Further, it should be noted that although specific examples presented herein include or reference specific components, an implementation of the components and methods disclosed and described herein is not necessarily limited to those specific components and can be employed in other contexts as well.

It should also be appreciated that although specific examples presented may describe or depict systems or methods that are based upon components of personal computers or mobile computing devices, the use of components and methods disclosed and described herein is not limited to those domains. For example, the disclosed and described components and methods can be used in a single- or special-purpose computing environment. Additionally or alternatively, the disclosed and described components and methods can be used on a single server accessed by multiple clients or a single source with multiple peers. Those of ordinary skill in the art will readily recognize that the disclosed and described components and methods can be used to create other components and execute other methods on a wide variety of computing devices.

FIG. 1 is a system block diagram of a display interface system 100. The display interface system 100 can generally be used to provide images on a display of a computing device. Specifically, the display interface system 100 can be used to provide video images on a display of a mobile computing device such as a cellular telephone, a personal digital assistant (PDA) or a portable gaming device, among others.

The display interface system 100 includes a transmission module 110. The transmission module 110 includes an application or multimedia processor 120. The application or multimedia processor 120 can be implemented as a general purpose processor such as a central processing unit (CPU) or can be a more specialized or dedicated processor such as a graphics processing unit (GPU) or an application-specific integrated circuit (ASIC). The application or multimedia processor 120 can be used to process or create graphical or video image information to be used in creating an image signal that ultimately can be used to form an image on a display. For ease of discussion, the terms image, graphical image, video image, and multimedia are sometimes used interchangeably. Except as necessary or appropriate in context, these terms should not necessarily be treated as mutually exclusive.

The transmission module 110 also includes a transmission display interface 130. The transmission display interface 130 can receive parallel image signals 125 from the application or multimedia processor 120 and can be implemented as part of a converter for transmission of image information to other components. In this particular example, the transmission display interface 130 can include appropriate electronics that can convert parallel image information into two pairs of scalable low-voltage signaling (SLVS) serial signals. Other appropriate converters can be used for the transmission display interface 130.

A reception module 140 can be coupled to the transmission module 110 to receive SLVS signals 150 from the transmission display interface 130 of the transmission module 110. The SLVS signals 150 can include pixel information carried on two SLVS differential pairs, as shown in this specific example. A coupling (not shown) between the transmission module 110 and the reception module 140 can be implemented as a flex cable or another appropriate data bus or data conduit as desired for a specific implementation.

A reception display interface 160 of the reception module 140 can receive the SLVS signals from the transmission display interface 130 of the transmission module 110. The reception display interface 160 can be implemented as a component of the previously-mentioned converter for image signals. In this example, the reception display interface 160 can convert the image information signals 150 from SLVS signals to parallel signals 165.

A liquid crystal display (LCD) driver 170 can receive the parallel signals 165 and use those signals to present image information signals 175 to an LCD display panel 180. The LCD display panel 180 can use the image information signals 175 to form a viewable image on a viewing surface. It should be noted that in this example, as well as others presented herein, other types of displays can be used in conjunction with, or in place of, the LCD display panel 180. Specifically contemplated displays include cathode ray tube displays, plasma displays, light emitting diode displays, organic light emitting diode displays, and electrophoretic displays, among others. Use of such displays can be accomplished with appropriate modifications to other components, including the LCD display driver 170. The nature and extent of such modifications should be apparent to and well within the abilities of one of ordinary skill in this art area.

In operation, the display interface system 100 can function as follows. The application or multimedia processor 120 of the transmission module 110 can create or generate image information that can be used by other components to create a viewable image on a display. The application or multimedia processor 120 can output that information in a parallel format and present the image information to the transmission display interface 130. The transmission display interface 130 can convert the parallel image information into serial image information for transmission as SLVS signals 150 over a flex cable or other suitable data link coupling.

The reception display interface 160 of the reception module 140 can receive the SLVS signals and convert the serial format of such signals to signals in a parallel format 165. The LCD display driver 170 can use the parallel image information to drive the LCD panel 180 that can form a viewable image on a viewing surface.

FIG. 2 is a system block diagram of a transmission display interface 200. The transmission display interface 200 can be used as the transmission display interface 130 of FIG. 1. Alternatively, the transmission display interface 200 can be used as part of another appropriate system to encode image information into a suitable format for use by a display driver and display unit.

The transmission display interface 200 includes an encoder 210. The encoder 210 can obtain image component information and format that data into a usable and predefined data format or structure. The encoder 210 can accept data from data buffers 215, 220, 225. Each of the data buffers 215, 220, 225 can accept one component of a red-green-blue (RGB) data signal. Information in the red, green, and blue signal components 230, 235, 240 can be stored in each of the data buffers 215, 220, 225, respectively. A data valid signal 245 can be used to signal that information in the red green and blue signal components 230, 235, 240 is valid and enable each of the data buffers 215, 220, 225 to accept the information in the red, green, and blue signal components.

In addition to RGB signal information, the encoder 210 can accept vertical synchronization information from a V-sync data signal 250 and horizontal synchronization information from an H-sync data signal 255. The encoder 210 can use the accepted input signals to create a data grouping in a predefined structure or format. In the case of video image information specifically, image information can be formatted to define image lines and frames. Encoded image information can be transmitted over a transmit data conduit 260. In the example presented, the transmit data conduit 260 is a 24-bit [23:0] data pathway. A wider or narrower data pathway can be used, depending upon details of a specific implementation.

The encoder 210 can generate a transmit enable signal 265 that can enable a high-speed serial link physical layer 270 to receive information in the transmit data conduit 260. The high-speed serial link physical layer 270 can send image information in differential pairs such as the signal differential pair 275 and the strobe differential pair 280. The signal differential pair 275 can carry image information. The strobe differential pair 280 can be used with the signal differential pair to recover a clock signal. Further details of transmission signals are provided in Table 1.

TABLE 1

| Signal name | Description |
|---|---|
| R [7:0] | Red component of display data. |
| G [7:0] | Green component of display data. |
| B [7:0] | Blue component of display data. |
| DV | Data valid. When asserted, it indicates that R, G, B are |
| | valid. |
| V-sync | Vertical sync signal. |
| H-sync | Horizontal sync signal. |
| TXDATA [23:0] | 24-bit parallel data. |
| TXE | Transmit enable. When asserted, it indicates that |
| | TXDATA are valid. |
| Signal diff. pair | Signal differential pair. Serial display data. |
| Strobe diff. pair | Strobe differential pair. Strobe signal that is used to |
| | recover clock signal together with the signal |
| | differential pair. |

In operation, the transmission display interface 200 can function as follows. Red, green, and blue image information signals 230, 235, 240 can be stored in buffers 215, 220, 225, respectively, when each of the buffers 215, 220, 225 is enabled by a data valid signal 245. The encoder 210 reads the red, green, and blue image information from each of the buffers 215, 220, 225 along with vertical synchronization information 250 and horizontal synchronization information 255. The encoder 210 formats the red, green, and blue image information along with the vertical and horizontal synchronization information into a predefined format.

When a transmission enable signal 265 is present, the formatted data is transmitted as a signal 260 to the high-speed serial link physical layer 270. The high-speed serial link physical layer 270 then transmits the formatted data as a signal differential pair 275 and a strobe differential pair 280.

FIG. 3 is a system block diagram of a reception display interface 300. The reception display interface 300 can be used as the reception display interface 160 of FIG. 1. Alternatively, the reception display interface 300 can be used as part of another appropriate system to decode image information into a suitable format for use by a display driver and display unit.

The reception display interface 300 includes a high-speed serial link physical layer 310. The high-speed serial link physical layer 310 can receive data signals, such as signals carried by the signal differential pair 315 and the strobe differential pair 320. A receive data signal 325 can be carried by the high-speed serial link physical layer 310 for storage in a buffer 330. The buffer can be enabled to receive the receive data signal 325 by a receive enable signal 335.

A decoder 340 can receive the receive data signal 325 stored in the buffer 330 and can decode the receive data signal 325 to recover image information. Specifically, the decoder 340 can recover a red component 345, a green component 350, and a blue component 355. A data valid signal 360 can indicate that image information for the red, green, and blue components 345, 350, 355 is valid for use. In addition to the red, green, and blue components 345, 350, 355, the decoder 340 can create a vertical synchronization signal 365 and a horizontal synchronization signal 370.

A pixel counter 375 can count pixels in the image signal received by the decoder 340. A line counter 380 can count lines in the image signal received by the decoder 340. The pixel counter 375 and the line counter 380 can be used to identify errors in line and frame formatting, respectively. Additional information regarding receive data signals is provided in Table 2.

TABLE 2

| Signal name | Description |
|---|---|
| R [7:0] | Red component of display data. |
| G [7:0] | Green component of display data. |
| B [7:0] | Blue component of display data. |
| DV | Data valid. When asserted, it indicates that R, G, B are |
| | valid. |
| V-sync | Vertical sync signal. |
| H-sync | Horizontal sync signal. |
| RXDATA [23:0] | 24-bit parallel data. |
| RXE | Receive enable. When asserted, it indicates that |
| | RXDATA are valid. |
| Signal diff. pair | Signal differential pair. Serial display data. |
| Strobe diff. pair | Strobe differential pair. Strobe signal that is used to |
| | recover clock signal together with the signal |
| | differential pair. |

In operation, the reception display interface 300 can function as follows. The high-speed serial link physical layer 310 receives the signal differential pair 315 and the strobe differential pair 320. When the receive enable signal 335 is present, image and synchronization information carried by the signal differential pair 315 and the strobe differential pair 320 is placed into a buffer 330. The decoder 340 reads the information from the buffer 330 and obtains the red component 345, the green component 350, and the blue component 355. Additionally, the decoder 340 recovers the vertical synchronization signal 365 and the horizontal synchronization signal 370. The decoder 340 also generates the data valid signal 360 to indicate that the information of the red component 345, the green component 350, and the blue component 355 is valid for use. The pixel counter 375 counts each pixel decoded to check for horizontal synchronization errors and the line counter 380 counts each line to check for vertical synchronization errors.

FIG. 4 is a record of a byte set 400. In this example, a total of four bytes [0:3] are shown. Each byte in this example consists of a total of eight bits [7:0]. In a specific implementation, a greater or fewer number of bytes can be used. Additionally, depending upon a specific implementation, a greater or fewer number of bits can be used for each byte. The byte set 400 can be used to encode display data and synchronization signals. Specifically, the byte set 400 can encode a single pixel of image data along with optional synchronization information.

The first byte 410, Byte 0, begins with a 1 value in bit 7. Bits 6:4 of Byte 0 contain a synchronization signal value, including a zero-filled value that indicates that a pixel associated with a byte that includes a zero-filled value is not associated with any synchronization information. Details of various synchronization signal values are provided in Table 3.

TABLE 3

| Sync signal | encoding | Description |
|---|---|---|
| NONE | 000 | Non-sync signal. Indicates |
| | | this pixel does not include |
| | | v-sync or h-sync |
| | | information. |
| V sync start (VS) | 001 | Vertical sync signal |
| | | received in the RGB |
| | | interface. Indicates first |
| | | line of a field. |
| V sync start + 1 (VSP) | 010 | Indicates second line of a |
| | | field. |
| V sync end (VE) | 011 | Indicates last line of a field. |
| V sync end − 1 (VEM) | 100 | Indicates the line preceding |
| | | the last line. |
| H sync start (HS) | 101 | Indicates the first pixel of a |
| | | line. This is the sync signal |
| | | received from the RGB |
| | | interface. |
| H sync start + 1 (HSP) | 110 | Indicates the second pixel |
| | | of a line. |
| H sync end (HE) | 111 | Indicates the last line of a |
| | | field. |

The first byte 410 also includes information relating to a red component of an encoded image signal. In particular, bits 0:2 of the red component are included in Byte 0. It should be noted that in this example a big-endian ordering scheme is used at the byte level and a little-endian ordering scheme is used at the bit level when describing RGB components. In a specific implementation, with appropriate modifications, another ordering scheme can also be used. Also, as shown and discussed in this example, a total of eight bits are used to encode RGB component information and a 24-bit RGB format is used. A total of 32 bits are used in this example to encode RGB data along with v-sync and h-sync information. As desired or required in a specific implementation, a different number of bits can be used to encode RGB and synchronization information.

Bit 0 of Byte 0 contains a parity bit. In this example, a 1 value indicates an odd number of 1 values in bits 7:1 of Byte 0. As desired or required for a specific implementation, another parity scheme can be used. Further information regarding the encoding used in Byte 0 is presented in Table 4.

TABLE 4

| Bit number | Name | Description |
|---|---|---|
| 7 | Byte ID | Set to 1 for the first byte. |
| 6:4 | Sync | See definition in Table 2. |
| 3:1 | R0:2 | Bits 0:2 of the red component of display data. |
| 0 | P | Parity bit. Set to 1 when the number of “1” in |
| | | bits 7 to 1 is an odd number; 0 otherwise. |

A second byte 420, Byte 1, includes a zero value in bit 7. Bits 6:3 contain the last four bits of the red component of the pixel that the byte set 400 encodes. The last two bits of Byte 1 contain the first two bits of an encoded green component of the pixel. Further details of an encoding of Byte 1 are included in Table 5.

TABLE 5

| Bit number | Name | Description |
|---|---|---|
| 7 | Byte ID | Always 0 for the second byte. |
| 6:2 | R3:7 | Bits 3:7 of the red components of display data. |
| 1:0 | G0:1 | Bits 1:0 of the green components of display data. |

A third byte 430, Byte 2, includes a zero value in bit 7. Bits 6:1 contain bits 2:7 of the green component of the pixel. Bit 0 of Byte 2 contains bit 0 of the blue component of the pixel. Further details of the encoding of Byte 2 are provided in Table 6 below.

TABLE 6

| Bit number | Name | Description |
|---|---|---|
| 7 | Byte ID | Always 0 for the third byte. |
| 6:1 | G2:7 | Bits 2:7 of the green |
| | | component of display data. |
| 0 | B0 | Bit 0 of the blue component |
| | | of display data. |

A fourth byte 440, Byte 3, includes a zero value at bit 7. Bits 6:0 contain the remaining seven bits of the blue component of the pixel encoded by the byte set 400. Further details of the encoding of Byte 3 are provided in Table 7 below.

TABLE 7

| Bit number | Name | Description |
|---|---|---|
| 7 | Byte ID | Always 0 for the fourth |
| | | byte. |
| 6-0 | G2--7 | Bits 2-7 of the green |
| | | component of display data. |

FIG. 5 is a record of a frame encoding 500. The frame encoding 500 can be used to format RGB image information. In addition, the frame encoding 500 can be used to format vertical and horizontal synchronization information for an image frame.

The frame encoding 500 includes a plurality of lines 510, 520, 530, 540, 550. Each of the plurality of lines 510, 520, 530, 540, 550 includes RGB image information and synchronization information. Redundant horizontal and vertical synchronization information is included in the frame encoding 500. In the exemplary frame encoding 500 depicted in FIG. 5, a 20×5 display frame is shown. It should be appreciated that other frame sizes can be used in other implementations with appropriate modifications to the number of pixels within in line or number of lines in a frame, or both.

The first line 510 of the plurality of lines can begin with a pixel 512 that can include a vertical synchronization start code that can indicate that the pixel 512 is the first pixel for the beginning of vertical synchronization for a frame. The pixel 512 can also include RGB image information for the first pixel of the frame. The pixel 512 can be followed by a pixel 514 that can include a horizontal synchronization start code that can indicate that the pixel 514 is the first pixel for the beginning of horizontal synchronization for the first line 510 of the plurality of lines. It should be noted that for the first line 510 of the plurality of lines, the first horizontal synchronization start code, found at pixel 514, can be HSP or horizontal synchronization start plus 1. In other lines, the HSP code can be used to designate the second horizontal synchronization start code at the beginning of a line. The second horizontal synchronization start code can provide redundancy for horizontal synchronization start information.

In this example, the vertical synchronization start information VS included in the pixel 512 can be understood to also be the first horizontal synchronization start signal for the line 510. Generally, as presented in this exemplary frame encoding, for a line that can include vertical synchronization information in a first pixel of that line, the vertical synchronization information in that first pixel can be understood or treated as also being horizontal synchronization start information for the respective line. In such case, a first pixel that can include a horizontal synchronization start code can include the HSP code.

The pixel 514 can also include RGB image information for the second pixel of the frame. This pixel 514 can be followed by a plurality of pixels that can include RGB image information without any synchronization information. The line 510 can be terminated by a pair of pixels, each of which can include horizontal synchronization end information. A pixel 516 can include horizontal synchronization end code HEM (horizontal synchronization minus 1) along with RGB image information. A pixel 518 can include horizontal synchronization end code HE along with RGB image information.

The line 520 can include a pixel 522 that can include vertical synchronization start code VSP; vertical synchronization start plus 1. This pixel 522 can provide redundant beginning vertical synchronization start information for a frame along with RGB image information for the pixel 522. A pixel 524 can include a horizontal synchronization start code HSP to provide redundant horizontal synchronization start information for the line 520 along with RGB image information for the pixel 524. This pixel 524 can be followed by a plurality of pixels that can include RGB image information without any synchronization information. The line 520 can be terminated by a pair of pixels, each of which can include horizontal synchronization end information. A pixel 526 can include horizontal synchronization end code HEM (horizontal synchronization minus 1) along with RGB image information for the pixel 526. A pixel 528 can include horizontal synchronization end code HE along with RGB image information for the pixel 528.

The line 530 can begin with a pair of pixels that can provide redundant horizontal synchronization start information for the line 530 along with RGB image information. A pixel 532 can include a horizontal synchronization start code HS along with RGB image information for the pixel 532. A pixel 534 can include a horizontal synchronization start code HSP along with RGB image information for the pixel 534. This pixel 534 can be followed by a plurality of pixels that can include RGB image information without any synchronization information. The line 530 can be terminated by a pair of pixels, each of which can include horizontal synchronization end information. A pixel 536 can include horizontal synchronization end code HEM (horizontal synchronization end minus 1) along with RGB image information for the pixel 536. A pixel 538 can include horizontal synchronization end code HE along with RGB image information for the pixel 538.

The line 540 can include a pixel 542 that can include vertical synchronization information code VEM; vertical synchronization end minus 1. This pixel 542 can provide redundant ending vertical synchronization information for a frame along with RGB image information for the pixel 542. A pixel 544 can include a horizontal synchronization start code HSP to provide redundant beginning horizontal synchronization information for the line 540, along with RGB image information for the pixel 544. This pixel 544 can be followed by a plurality of pixels that can include RGB image information without any synchronization information. The line 540 can be terminated by a pair of pixels, each of which can include horizontal synchronization end information. A pixel 546 can include horizontal synchronization code HEM (horizontal synchronization end minus 1) along with RGB image information for the pixel 546. A pixel 548 can include horizontal synchronization end code HE along with RGB image information for the pixel 548.

The line 550 can include a pixel 552 that can include vertical synchronization information code VEM; vertical synchronization end minus 1. This pixel 552 can provide ending vertical synchronization information for a frame along with RGB image information for the pixel 552. A pixel 554 can include a horizontal synchronization start code HSP to provide redundant beginning horizontal synchronization information for the line 550, along with RGB image information for the pixel 554. This pixel 554 can be followed by a plurality of pixels that can include RGB image information without any synchronization information. The line 550 can be terminated by a pair of pixels, each of which can include horizontal synchronization end information. A pixel 556 can include horizontal synchronization code HEM (horizontal synchronization end minus 1) along with RGB image information for the pixel 556. A pixel 558 can include horizontal synchronization end code HE along with RGB image information for the pixel 558.

In addition to parity checking, redundant synchronization signals can be used to check for data errors. For each line there are four bytes that can contribute to detection of a horizontal synchronization signal. If these four bytes do not agree, such as in a case where one or more bytes indicate a beginning or an end of a line while other bytes indicate a middle of a line, a synchronization error can be detected. Similarly, for vertical synchronization signals, up to four bytes can be available to indicate a start of an end of a display frame.

Additional error checking capabilities can be provided through use of a pixel counter or a line counter, or both. Such a pixel counter or line counter can be implemented as the pixel counter 370 or the line counter 375 of FIG. 3, respectively. Other suitable pixel counters or line counters, or both, can also be employed. An employed pixel counter can be used to count pixels and detect lines. A line counter can be used to count lines and detect frames. One method that can be used to increment the line counter is detection of all four bytes of a line that indicate a horizontal synchronization signal. Other methods can also be employed.

To correct for errors, a majority-rule approach can be used. A synchronization signal can be generated if most bytes indicate that a synchronization signal is present. If a synchronization signal generation decision cannot be made according to this rule, a decision can be made based upon the pixel counter and the line counter. Other approaches can be used, including, for example, placing greater weight upon specific pixels or using some other combination of factors.

FIG. 6 is a flow diagram depicting a general processing flow of a method 600 that can be employed in accordance with components previously disclosed and described. The method can be used to send formatted image data, including synchronization information, from a processor to a display. Specifically, the method can be used to format image data, convert such data from a parallel format to a serial format for high-speed transmission, convert the image data from serial format to parallel format, and use the data to form an image on a display.

Processing of the method 600 begins at START block 610 and continues to process block 615 where image data is generated by a processor. At process block 620 image data is sent to a transmission interface. Processing continues at process block 625 where the image data is formatted into a predefined structure.

Parallel image data is converted into a serial format at process block 630. At process block 635 the image data is transmitted using differential pairs. The transmitted data is received at process block 640. Conversion from serial format to parallel format occurs at process block 645. Processing of the method 600 continues at process block 650 where the image data is sent to a display driver. At process block 655 an image is formed on a viewing surface of a display. Processing of the method 600 terminates at END block 660.

FIG. 7 is a flow diagram depicting a general processing flow of a method 700 that can be employed in accordance with components previously disclosed and described. The method can be used to format image data and send formatted image data, to components for display. Processing of the method 700 begins at START block 710 and continues to process block 715 where RGB signals are placed in a buffer. At decision block 720 a determination is made whether image data in the form of RGB signals in the buffer are valid. If no, processing returns to process block 715. If yes, processing continues to process block 725 where the RGB image data read from the buffers.

Horizontal and vertical synchronization information is read at process block 730. At process block 735 the image data, including horizontal and vertical synchronization information, is encoded into a predetermined format. The encoded data is transmitted over a serial link at process block 740. At decision block 745 a determination is made whether reading the transmitted encoded data has been enabled. If no, processing returns to process block 740. If yes, processing of the method 700 continues at process block 750 where read data is converted to a serial format. At process block 755 differential pair signals are created from the serial data. Processing of the method 700 terminates at END block 760.

FIG. 8 is a flow diagram depicting a general processing flow of a method 800 that can be employed in accordance with components previously disclosed and described. The Method can be used to receive serial formatted image data, including synchronization information, convert the image data from serial format to parallel format, and use the data to form an image on a display.

Processing of the method 800 begins at START block 810 and continues to process block 815 where differential pair signals are received. At decision block 820 a determination is made whether reading of the differential pair signals is enabled. If no, processing returns to process block 815. If yes, processing continues to process block 825 where the signal data is placed in the buffer.

Information is read from the buffer at process block 830. At process block 835 the image data, including horizontal and vertical synchronization information, is decoded. Pixels of the decoded information are counted at process block 840 to check for horizontal synchronization errors. At decision block 845 a determination is made whether a horizontal synchronization error has occurred. If yes, processing continues to process block 850 where the majority rule is applied to correct the error. If the determination made at decision block 845 is no, processing continues to decision block 855 where a determination is made whether a vertical synchronization error has occurred. If yes, processing continues to process block 860 where the majority rule is applied to correct the error. If the determination made at decision block 855 is no, processing continues to process block 865. At process block 865 data is sent to the display driver. An image is formed on a viewing surface of a display at process block 870. Processing of the method 800 concludes at END block 875.

What has been disclosed and described above includes various examples and specific implementations. It is not possible to describe every conceivable combination of components or methods that can be created, but one of ordinary skill in the art will recognize from reading this disclosure that many further combinations and permutations of the disclosed and described systems, components, and methods are possible.

In particular and in regard to the various functions performed by the disclosed and described components, devices, circuits, systems and the like, terms (including a reference to a “means”) used to describe such components are intended to correspond, unless otherwise indicated, to any component that performs the specified function of the described component even though not structurally equivalent to the disclosed structure.

In addition, while a particular feature may have been disclosed or described with respect to only one of several implementations, such feature may be combined with one or more other features of the other implementations as desired or necessary for any given or particular application. Additionally, to the extent that the terms “includes,” and “including” and variants thereof are used in either the detailed description or the claims, these terms are intended to be construed in a manner similar to the term “comprising.”

We claim:

1. An apparatus for encoding video display data, comprising:
a transmitter that is configured to accept an RGB data signal from a source; and
a receiver that is configured to accept the RGB data signal from the transmitter;
wherein the RGB data signal comprises redundant synchronization information.

2. The apparatus of claim 1, wherein the redundant synchronization information comprises redundant horizontal synchronization information.

3. The apparatus of claim 2, wherein the redundant synchronization information comprises redundant vertical synchronization information.

4. The apparatus of claim 3, further comprising an error detection unit that is configured to detect horizontal synchronization errors.

5. The apparatus of claim 4, wherein the error detection unit is configured to detect horizontal synchronization errors by counting pixels of a line.

6. The apparatus of claim 5, wherein the error detection unit is configured to detect vertical synchronization errors.

7. The apparatus of claim 6, wherein the error detection unit is configured to detect vertical synchronization errors by counting lines of a frame.

8. The apparatus of claim 7, further comprising an application processor that is configured to provide the RGB data signal.

9. The apparatus of claim 8, further comprising a display that is configured to use the RGB signal to form an image.

10. The apparatus of claim 9, wherein the display is a display selected from the group consisting of a cathode ray tube, a plasma display, a liquid crystal display, a light emitting diode display, an organic light emitting diode display, and an electrophoretic display.

11. A method for using display image information, comprising:
formatting RGB image information into a frame comprising a plurality of lines, each line comprising a plurality of cells;
defining the frame by setting a vertical synchronization value at an initial cell of an initial line of the frame and setting a horizontal synchronization value at a terminal cell of a terminal line of the frame; and
setting redundant synchronization information in at least one cell of the plurality of cells of the plurality of lines in the frame.

12. The method of claim 11, wherein setting redundant synchronization information includes setting redundant horizontal synchronization information in at least one of the plurality of cells of the plurality of lines of the frame.

13. The method of claim 12, wherein setting redundant synchronization information includes setting redundant vertical synchronization information in at least one of the plurality of cells of the plurality of lines of the frame.

14. The method of claim 13, further comprising detecting synchronization errors by counting cells in at least one of the plurality of lines of the frame.

15. The method of claim 14, further comprising detecting synchronization errors by counting lines of the frame.

16. A system for using display image information, comprising:
means for formatting RGB image information into a frame comprising a plurality of lines, each line comprising a plurality of cells;
means for defining the frame by setting a vertical synchronization value at an initial cell of an initial line of the frame and setting a horizontal synchronization value at a terminal cell of a terminal line of the frame; and
means for setting redundant synchronization information in at least one cell of the plurality of cells of the plurality of lines in the frame.

17. The system of claim 16, wherein the means for setting redundant synchronization information includes means for setting redundant horizontal synchronization information in at least one of the plurality of cells of the plurality of lines of the frame.

18. The system of claim 17, wherein the means for setting redundant synchronization information includes means for setting redundant vertical synchronization information in at least one of the plurality of cells of the plurality of lines of the frame.

19. The system of claim 18, further comprising means for detecting synchronization errors by counting cells in at least one of the plurality of lines of the frame.

20. The system of claim 19, further comprising means for detecting synchronization errors by counting lines of the frame.
